(19) United States
(12) Patent Application Publication
(10) Pub. No.: US 2009/0136143 A1
(43) Pub. Date: May 28, 2009

(54) TRANSMITTING AND RECEIVING METHOD FOR PROCESSING IMAGE FRAMES, AND DATA PROCESSING APPARATUS USING THE SAME

(75) Inventor: Yoshiyuki Otani, Anpachi-gun (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD.

(21) Appl. No.: 12/277,642

(22) Filed: Nov. 25, 2008

(30) Foreign Application Priority Data
Nov. 26, 2007 (JP) 2007-304757

(51) Int. Cl. G06K 9/36

(52) U.S. Cl. 382/232

(57) ABSTRACT

An image frame input unit receives the input of image frames. An insertion unit inserts a plurality of markers into the image frame thus inputted. Each of the plurality of markers is defined as a pattern that is not scheduled to appear in data of the image frame. At this time, the insertion unit divides the image frame into a plurality of parts based on a data size storable in a radio packet, and inserts the markers among the divided parts of the image frame. An RF unit outputs the image frame into which the plurality of markers have been inserted.

### CROSS-REFERENCE TO RELATED APPLICATIONS

This application is based upon and claims the benefit of priority from the prior Japanese Patent Application No. 2007-304757, filed on Nov. 26, 2007, the entire contents of which are incorporated herein by reference.

### BACKGROUND OF THE INVENTION

1. Field of the Invention

The present invention relates to a transmitting technique and a receiving technique, in particular, to a transmitting method and a receiving method for processing image frames and a data processing apparatus utilizing the transmitting and receiving method.

2. Description of the Related Art

JPEG (Joint Photographic Experts Group) is one of international standards for compression technology for compressing still images. In JPEG, original image data (hereinafter referred to as “original frames”) are subjected to DCT (Discrete Cosine Transform), quantization and entropy coding. The format of data compressed under JPEG is such that marker (hereinafter referred to as “header marker”), header, image data and marker (“end marker”) are assigned in this order from the header position. Note that the image data correspond to data where the original frames have been compressed.

There are cases where the compressed data are transmitted from a transmitting apparatus to a receiving apparatus. In such a case, a wired network or a wireless network is used. As the wireless network, a wireless LAN (Local Area Network) complying with IEEE 802.11a and the like is used, for instance. In such a wireless LAN system, data are stored in packet signal and this packet signal is transmitted. The size of packet signal is defined as about 1500 bytes maximum, for instance. When TCP/IP is used, the maximum size is 1472 bytes. When network protocols are not used, the maximum size is 4096 bytes.

For the clarity of explanation, the maximum size is set to 1500 bytes in what is to follow, but the application is not limited thereto. On the other hand, the size of image data depends on the size of original frames and may exceed the maximum size of the packet signal. In such a case, the transmitting apparatus of wireless LAN divides the original data into a plurality of portions and transmits these in a plurality of packet signals. The receiving apparatus receives the plurality of packet signals. Since the original frames are acquired by decoding the image data, entire image data must be received. In order to shorten the period of time required for the receiving processing, it is desired that the confirmation on whether the entire image data are received or not be done easily.

### SUMMARY OF THE INVENTION

The present invention has been made under the foregoing circumstances, and a general purpose thereof is to provide a technique by which to easily verify whether all image data are received or not.

In order to resolve the above problems, a data processing apparatus according to one embodiment of the present invention comprises: an input unit which inputs an image frame; an insertion unit which inserts a plurality of markers into the image frame inputted by the input unit wherein each marker is defined as a pattern that is not scheduled to appear in data of the image frame; and an output unit which outputs the image frame into which the plurality of markers are inserted by the insertion unit. The insertion unit divides the image frame into a plurality of parts based on a data size storable in a radio packet, and inserts the markers between the divided parts of the image frame.

Another embodiment of the present invention relates to a data processing apparatus. This apparatus comprises: an input unit which inputs a plurality of divided parts of an image frame, respectively; and a processing unit which processes the image frame, inputted by the input unit, which has been divided into the plurality of parts. The image frame inputted by the input unit is such that an original image frame is divided into a plurality of parts based on a data size storable in a radio packet, and a marker defined as a pattern that is not scheduled to appear in data of the original frame is appended to each image frame; and the processing unit recognizes an acquisition status of the each image frame based on the marker.

Still another embodiment of the present invention relates to a transmitting method. This method comprises: inputting an image frame; inserting a plurality of markers into the image frame inputted by the inputting wherein the marker is defined as a pattern that is not scheduled to appear in data of the image frame; and outputting the image frame into which the plurality of markers have been inserted. The inserting divides the image frame into a plurality of parts based on a data size storable in a radio packet and inserts the markers among the divided parts of the image frame.

Still another embodiment of the present invention relates to a receiving method. This method comprises: inputting a plurality of divided parts of an image frame, respectively; and processing the image frame, inputted by the inputting, which has been divided into the plurality of parts. The image frame inputted by the inputting is such that an original image frame is divided into a plurality of parts based on a data size storable in a radio packet, and a marker defined as a pattern that is not scheduled to appear in data of the original frame is appended to each image frame; and the processing recognizes an acquisition status of the each image frame based on the marker.

Optional combinations of the aforementioned constituting elements, and implementations of the invention in the form of methods, apparatuses, systems, recording mediums, computer programs and so forth may also be practiced as additional modes of the present invention.

### BRIEF DESCRIPTION OF THE DRAWINGS

Embodiments will now be described by way of examples only, with reference to the accompanying drawings which are meant to be exemplary, not limiting, and wherein like elements are numbered alike in several Figures in which:

FIG. 1 shows a structure of a transmitting apparatus according to an exemplary embodiment;

FIGS. 2A to 2E show formats of image data processed by the transmitting apparatus of FIG. 1;

FIG. 3 shows a structure of a receiving apparatus according to an exemplary embodiment of the present invention;

FIG. 4 is a sequence diagram showing a communication procedure according to an exemplary embodiment of the present invention;

FIG. 5 is a flowchart showing a transmitting procedure in the transmitting apparatus of FIG. 1;

FIG. 6 is a flowchart showing a receiving procedure in the receiving apparatus of FIG. 3; and

FIGS. 7A to 7E show formats of image data processed in a modification of an exemplary embodiment.

### DETAILED DESCRIPTION OF THE INVENTION

The invention will now be described by reference to the preferred embodiments. This does not intend to limit the scope of the present invention, but to exemplify the invention.

The present invention will be outlined hereinbelow before it is described in detail. Exemplary embodiment of the present invention relates to a communication system. In a transmitting side of the communication system, image data are generated by compressing original data and transmitted; and in a receiving side of the communication system, the image data are reproduced. Here, a wireless communication is used in the transfer of data from the transmitting side to the receiving side, and packet signals are used in the wireless communication. If the size of image data is larger than the size of packet signal, the transmitting side will divide the image data into a plurality of small portions and the thus divided small portions of the image data are stored in the packet signals. As a result, a plurality of packet signals are transmitted for a single original frame. After it has been verified that all packet signals for the single original frame are received, the receiving side reproduces the image data. For instance, if some of image data are discarded, the receiving side makes a request to the transmitting side that the discarded image data be retransmitted. In this case, the request of the retransmission may not be made and said image data may be discarded. However, the description of such a processing is omitted here. To shorten the period of time for retransmission processing or to simplify the receiving verification, the communication system according to the present exemplary embodiment performs the following processings.

If the image data are divided and stored in the packet signals, the transmitting side will insert a plurality of markers in the image data in a manner such that each marker is contained in each packet signal. Here, the markers are defined as patterns which are not scheduled to appear in the image data. Numbers indicating the sequence are contained in the plurality of markers. For example, the numbers “1” to “8” are assigned in sequence. After “8”, the sequence returns to “1” and this will be repeated. The transmitting side inserts the markers “1” to “8” into the image data as one unit. The transmitting side divides each image data, to which markers have been inserted, into a plurality of parts and stores the thus divided parts of image data in the packet signals. The transmitting side transmits the packet signals, and the receiving side receives the packet signals. Upon receipt of the packet signals, the receiving side verifies the receiving of the image data based on the markers.

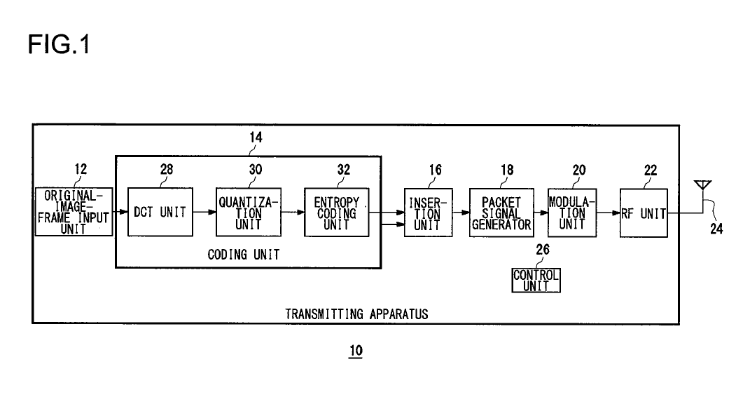

FIG. 1 shows a structure of the transmitting apparatus 10 according to the present exemplary embodiment. The transmitting apparatus 10 includes an original-image-frame input unit 12, a coding unit 14, an insertion unit 16, a packet signal generator 18, a modulation unit 20, an RF unit 22, a transmitting antenna 24, and a control unit 26. The coding unit 14 includes a DCT unit 28, a quantization unit 30, and an entropy coding unit 32.

The original-image-frame input unit 12 receives the input of original image frames. Here, the original frame corresponds to an image on which no compression has been performed. For example, the original image frames are digital data of images picked up by a digital camera. In the following description, the term “original image frame” is used with no distinction between the image per se and the digital data thereof. The DCT unit 28, the quantization unit 30 and the entropy coding unit 32 compress and code the original image frames, received by the original-image-frame input unit 12, in compliance with JPEG. Since any known technique may be used as a JPEG compression processing, the descriptions of the DCT unit 28, the quantization unit 30 and the entropy coding unit 32 are omitted here. Finally, the entropy coding unit 32 outputs the JPEG-compressed image data and also outputs various pieces of information in JPEG (hereinafter referred to as “JPEG information”).

The insertion unit 16 receives the image data and the JPEG information from the entropy coding unit 32. The insertion unit 16 generates JPEG headers based on the JPEG information and assigns each JPEG header anterior to image data. The insertion unit 16 appends markers to the header and the tail, respectively. Here, the marker appended to the header is “SOI (Start of Image)”, whereas the marker appended to the tail is “EOI (End of Image)”. Note that the markers are defined as patterns that are not scheduled to appear in the image data.

The insertion unit 16 divides an image frame into a plurality of parts, based on a data size which can be stored in the packet signal. For example, though the size of packet signal is variable in the case of wireless LAN, the maximum size is defined to be 1500 bytes. Since control information that does not belong to data is also contained in the packet signal, the value obtained after the value of the control information is subtracted from 1500 bytes is defined to be the data size storable in the packet signal. The value of control information is also variable and the value thereof is not exactly known to the insertion unit 16. Hence, assume herein that the value thereof is predetermined as a fixed value. The size of packet signal may be defined to be less than 1500 bytes instead of 1500 bytes. The insertion unit 16 also inserts markers into the divided parts of image data. That is, the insertion unit 16 inserts a plurality of markers into the image data.

The insertion unit 16 defines a predetermined number of markers as each combination of markers. The insertion unit 16 inserts them in units of an integral multiple of the number of markers contained in one combination. Here, “8” markers are defined to constitute one combination of markers. Accordingly, the insertion unit 16 divides the image data into at least nine parts, and inserts markers into each of the divided parts. If, as already mentioned, the size of image data divided into nine parts is larger than the data size storable in the packet signal, the insertion unit 16 will divide the image data into “17”, “25” or the like parts so that markers the number of which is an integral multiple of 8 can be inserted. The insertion unit 16 inserts markers the number of which is an integral multiple of 8. Here, the insertion unit 16 assigns mutually different identification numbers to eight markers in one combination of them, respectively. That is, the identification numbers “1” to “8” are assigned in order from the beginning. If markers beyond “8” are to be inserted, the insertion unit 16 will repeatedly use the identification numbers used for a certain combination, for each marker in different combinations. In other words, the identification numbers “1” to “8” are used repeatedly.

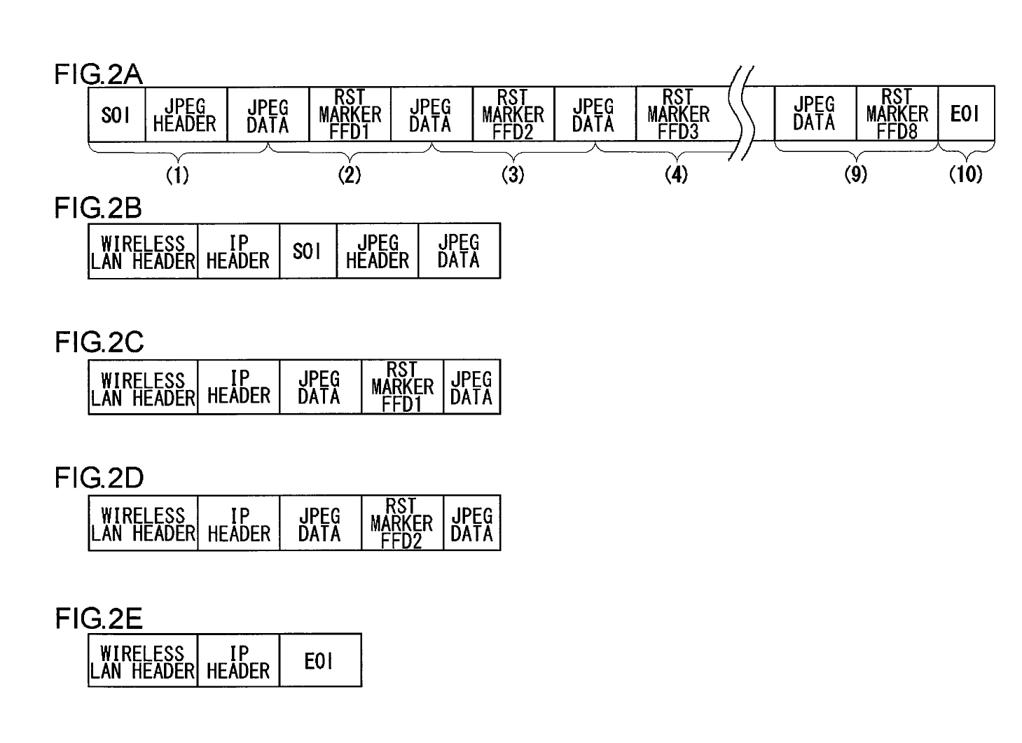

FIGS. 2A to 2E show formats of image data processed by the transmitting apparatus 10. The format generated by the insertion unit 16 corresponds to that of FIG. 2A. “JPEG data” in FIG. 2A correspond to the aforementioned divided parts of image data. “RST marker FFD1” to “RST marker FFD8” correspond to the markers inserted into the image data. The patterns of markers actually inserted correspond to “FFD1” to “FFD8”. An RST marker is a restart interval termination marker and is primarily defined to be used for another usage. Now refer back to FIG. 1.

The packet signal generator 18 receives, from the insertion unit 16, the image data into which a plurality of markers have been inserted. The packet signal generator 18 divides the received image data into a plurality of parts, thereby generating a plurality of packet signals. Note here that the packet signal generator 18 divides the image data into a plurality of parts so that markers can be contained in the plurality of parts. SOI and EOI are contained in such markers. FIGS. 2B to 2E show structures of packet signals generated by the packet signal generator 18. In each of the packet signals shown in FIGS. 2B to 2E, a wireless LAN header and an IP header are assigned in this order from the beginning but these belong to a known art and therefore the description thereof is omitted here. The packet signal of FIG. 2B stores component (1) of FIG. 2A; the packet signal of FIG. 2C stores component (2) of FIG. 2A; the packet signal of FIG. 2D stores component (3) of FIG. 2A; and the packet signal of FIG. 2E stores component (10) of FIG. 2A.

The modulation unit 20 modulates a plurality of packet signals. The modulation scheme used here may be optional. The modulation unit 20 outputs modulated packet signals. The RF unit 22 receives the packet signals from the modulation unit 20. Here, the packet signal corresponds to a baseband-band signal, and the RF unit 22 performs quadrature modulation on the packet signal so as to frequency-convert it from the baseband band to the intermediate-frequency band. Further, the RF unit 22 generates radiofrequency-band packet signals by frequency-converting intermediate-frequency-band packet signals. After amplifying the radiofrequency-band packet signals, the RF unit 22 transmits the amplified radiofrequency-band packet signals via the transmitting antenna 24. The control unit 26 controls the timing and the like of the transmitting apparatus 10 as a whole.

This structure may be implemented hardwarewise by elements such as a CPU, memory and other LSIs of an arbitrary computer, and softwarewise by memory-loaded programs having communication functions or the like. Depicted herein are functional blocks implemented by cooperation of hardware and software. Therefore, it will be obvious to those skilled in the art that the functional blocks may be implemented by a variety of manners including hardware only, software only or a combination of both.

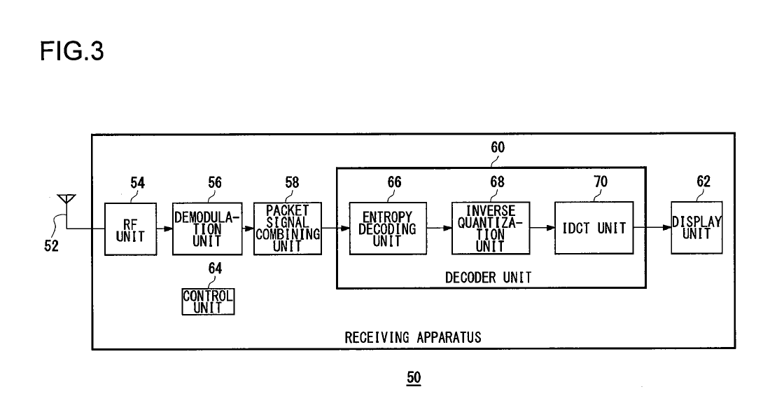

FIG. 3 shows a structure of a receiving apparatus 50 according to an exemplary embodiment of the present invention. The receiving apparatus 50 includes a receiving antenna 52, an RF unit 54, a demodulation unit 56, a packet signal combining unit 58, a decoder unit 60, a display unit 62, and a control unit 64. The decoder unit 60 includes an entropy decoding unit 66, an inverse quantization unit 68, and an IDCT unit 70.

The RF unit 54 receives packet signals via the receiving antenna 52. The packet signal is a radiofrequency-band signal, and the RF unit 54 frequency-converts the packet signals from a radiofrequency band to an intermediate frequency band. Further, the RF unit 54 performs quadrature detection on the packet signals of the intermediate frequency band so as to generate baseband-band packet signals. The demodulation unit 56 receives the packet signals from the RF unit 54. The demodulation unit 56 demodulates the packet signals. Further, the demodulation unit 56 outputs the demodulated packet signals.

The packet signal combining unit 58 receives a plurality of packet signals from the demodulation unit 56. Here, the received packet signals are structured as shown in FIGS. 2B to 2E. The packet signal combining unit 58 extracts markers, JPEG headers and image data from the plurality of packet signals by removing wireless LAN headers and IP headers therefrom. The packet signal combining unit 58 recognizes the acquisition status of each image data, based on the markers. For example, the presence of the image data to which SOI has been appended and the image data to which EOI has been appended allows the packet signal combining unit 58 to recognize the acquisition of the leading image data and the rearmost (ending) image data. The presence of markers composed of a combination of “1” to “8” allows the packet signal combining unit 58 to recognize the acquisition of the other image data.

For example, assume that the marker corresponding to “8” is missing. Since the packet signal combining unit 58 recognizes beforehand that each combination is composed of markers “1” to “8”, the packet signal combining unit 58 can recognize that said marker is missing. Even if more than eight markers are appended, the same processing will be executed. The packet signal combining unit 58 finally combines together the image data, which have been divided into a plurality of parts, so as to generate a single piece of image data. As a result, the packet signal combining unit 58 outputs a piece of image data. If any part of image data which has not been acquired yet is detected, the packet signal combining unit 58 may request the not-shown transmitting apparatus 10 to retransmit such image data.

The entropy decoding unit 66, the inverse quantization unit 68 and the IDCT unit 70 perform decoding complied with JPEG compression, on the image data outputted from the packet signal combining unit 58. Since any known technique may be used for the decoding, the descriptions of the entropy decoding unit 66, the inverse quantization unit 68 and the IDCT unit 70 are omitted here. Finally, the IDCT unit 70 outputs image frames. The image frames may be identical to the original image frames. The display unit 62 receives the image frames from the IDCT unit 70 and displays the image frames as images. The control unit 64 controls the timing and the like of the receiving apparatus 50 as a whole.

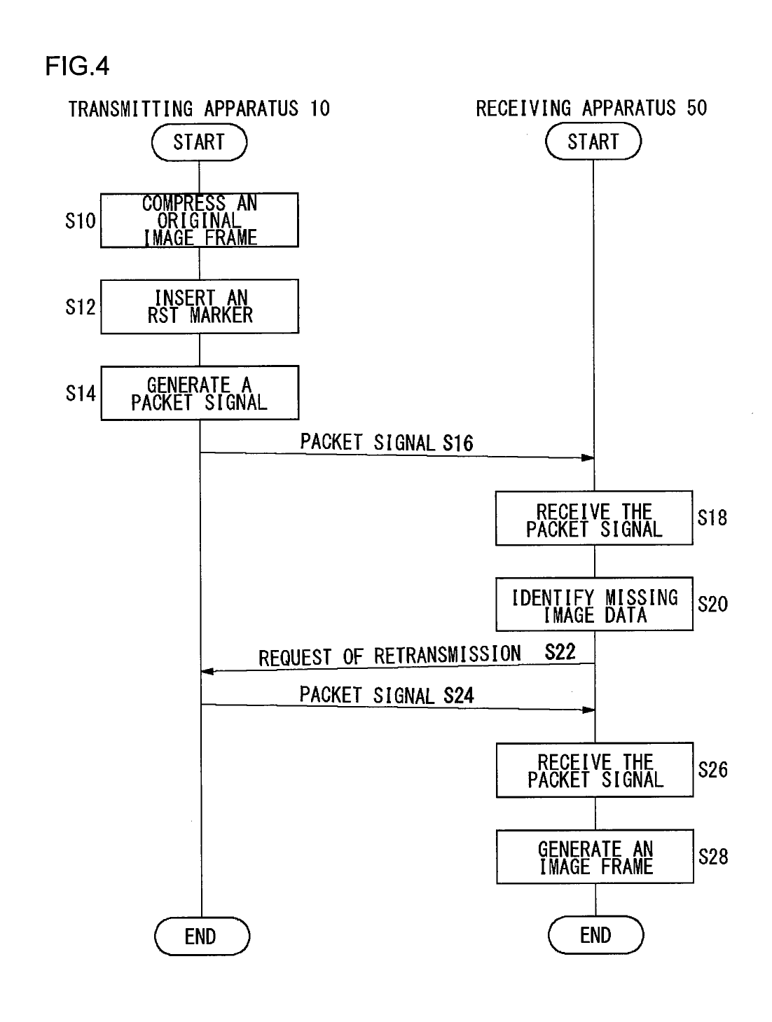

An operation of the communication system structured as above is now described. FIG. 4 is a sequence diagram showing a communication procedure according to the present exemplary embodiment of the present invention. The transmitting apparatus 10 compresses the original image frames (S10). The transmitting apparatus 10 inserts RST markers into the image data (S12) and then generates packet signals (S14). The transmitting apparatus 10 transmits the packet signals to the receiving apparatus 50 (S16). Upon receipt of the packet signals (S18), the receiving apparatus 50 identifies missing parts of image data based on the markers (S20). As the receiving apparatus 50 has transmitted a retransmission request to the transmitting apparatus 10 (S22), the transmitting apparatus 10 transmits a packet signal to the receiving apparatus 50 (S24). Upon receipt of the packet signal (S26), the receiving apparatus 50 generate an image frame (S28).

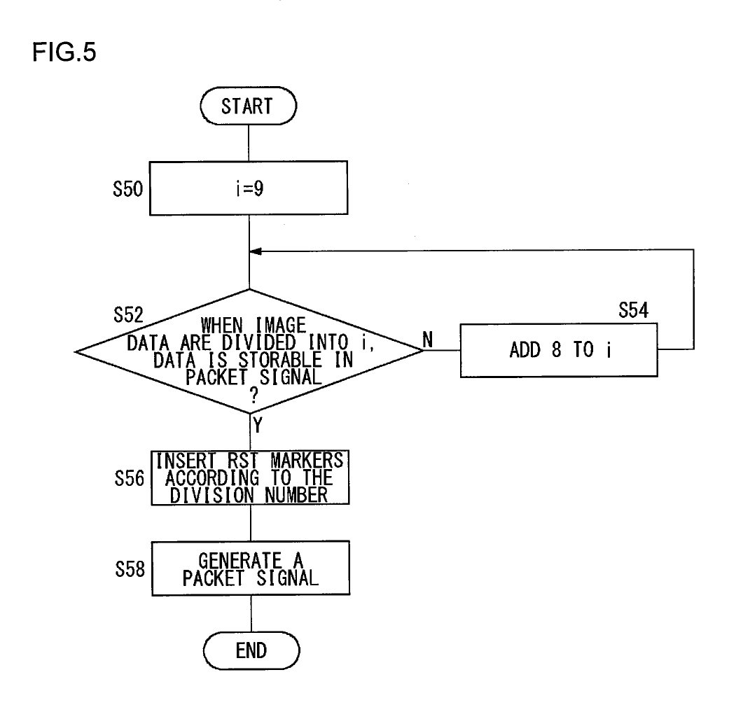

FIG. 5 is a flowchart showing a transmitting procedure in the transmitting apparatus 10. The insertion unit 16 sets i to “i=9” (S50). When the image data is divided into “i” parts but each of those parts cannot be stored in the packet signal (N of S52), “8” is added to “i” (S54) and the procedure returns to Step 52. On the other hand, when the image data is divided into “i” parts and each of those parts can be stored in the packet signal (Y of S52), the insertion unit inserts RST markers according to the division number (S56). The packet signal generator 18 generates packet signals (S58).

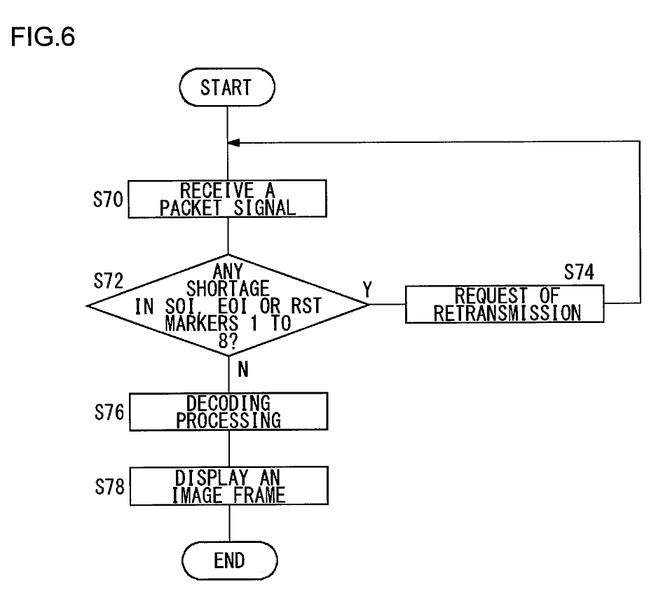

FIG. 6 is a flowchart showing a receiving procedure in the receiving apparatus 50. The RF unit 54 receives packet signals (S70). If there is any part that is missing in SOI, EOI and the RST markers of 1 to 8 (Y of S72), the packet signal combining unit 58 will request the transmitting apparatus 10 to retransmit the missing parts (S74) and the procedure will be returned to Step 70. On the other hand, if there is no part missing in SOI, EOI and the RST markers of 1 to 8 (N of S72), the decoder unit 60 will perform the decoding processing (S76). The display unit 62 displays the image frames (S78).

A modification of the exemplary embodiment will now be described. In the above-described embodiment, the eight markers are combined together as a predetermined set and an image frame is divided on the basis of markers the number of which is an integral multiple of 8. The identification numbers “1” to “8” are assigned to the eight markers, respectively. In this modification, the markers where the identification numbers “1” to “8” are assigned similarly to the exemplary embodiment are used but the image frame is divided based on the number which is different from the integral multiple of 8. For example, one example of such a case may be where the markers to which “1” to “4” only are assigned are used. In this case, too, the transmitting apparatus 10 must convey to the receiving apparatus 50 the rearmost part of the divided packet signals. In order to cope with this, the modification is configured as follows.

The structure of the transmitting apparatus 10 according to the modification is of the same type as that shown in FIG. 1, whereas the structure of the receiving apparatus 50 according to the modification is of the same type as that shown in FIG. 3. A description is given here of the modification centering around differences from the exemplary embodiment. As described above, the insertion unit 16 in the transmitting apparatus 10 assigns the JPEG header anteriro to the image data. The insertion unit 16 appends “SOI” and “EOI” to the header and the tail, respectively. The insertion unit 16 defines a predetermined number of markers as a combination of markers and defines “8” markers here also as one combination of markers. The identification numbers “1” to “8” are assigned respectively to the eight markers. In the exemplary embodiment, the insertion unit 16 inserts markers the number of which is an integral multiple of 8 but the number of markers here may be other than an integral multiple of 8. For the clarity of description, assume here that the number of markers is “4”.

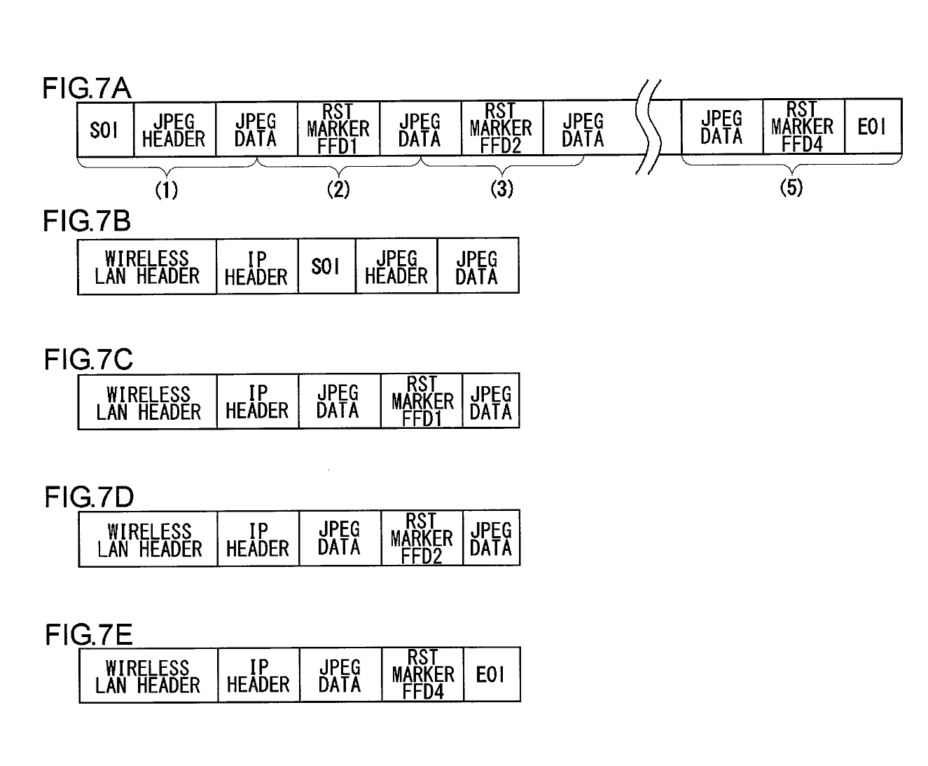

FIGS. 7A to 7E show formats of image data processed in the modification. The format generated by the insertion unit 16 corresponds to that of FIG. 7A. FIG. 7A is similar to FIG. 2A but differs therefrom in “RST marker FFD1” to “RST marker FFD 4”. As shown in FIG. 7A, “RST marker FFD4”, namely the rearmost marker, may be coupled with “EOI”.

The packet signal generator 18 receives, from the insertion unit 16, the image data into which a plurality of markers have been inserted. The packet signal generator 18 divides the received image data into a plurality of parts, thereby generating a plurality of packet signals. Note here that the packet signal generator 18 divides the image data into a plurality of parts so that markers can be contained in the plurality of parts. The packet signal generator 18 has the marker, to which the last identification number has been assigned, contained in the rearmost packet. In other words, “RST marker FFD4” and “EOI” are contained in the rearmost packet. FIGS. 7B to 7E show structures of packet signals generated by the packet signal generator 18. The packet signal of FIG. 7B stores component (1) of FIG. 7A; the packet signal of FIG. 7C stores component (2) of FIG. 7A; the packet signal of FIG. 7D stores component (3) of FIG. 7A; and FIGS. 7B to 7D are identical to FIG. 2B to FIG. 2D. On the other hand, The packet signal of FIG. 7E stores component (5) of FIG. 7A. As shown in FIG. 7E, “EOI” is appended in addition to “RST marker FFD4”. The packet signal generator 18 outputs a plurality of packet signals.

In the receiving apparatus 50, the packet signal combining unit 58 recognizes the acquisition of the leading image data and the rearmost image data by verifying the presence of the image data to which SOI has been appended and the image data to which EOI has been appended. A marker to which an identification number has been assigned is also appended to the image data to which EOI has been appended. The packet signal combining unit 58 recognizes the last identification number by acquiring the identification number of this marker. For example, if “RST marker FFD4” is appended, the packet signal combining unit 58 will recognize that the last identification number is “4”. As a result, similar to the exemplary embodiment, the packet signal combining unit 58 can recognize that a marker is missing, the description of which is omitted here.

According to the exemplary embodiment, image data is divided into a plurality of parts based on the data size storable in the packet signal, and markers are inserted among the divided parts of the image frame. Thus, markers can be contained in each packet signal. Since the markers are contained in each packet signal, whether the whole of image data has been received or not can be easily verified. Since the verification can be performed easily, a missing part of image data, if any, can be identified promptly. Since any missing parts of image data are identified promptly, the retransmission request can be transmitted at once. Since the retransmission request is transmitted at once, processing delay can be reduced. Since the processing delay is reduced, user convenience can be improved. RST markers are used, instead, as the markers, so that the current standards apply. Since eight markers are used as a predetermined combination of markers, a missing marker, if any, can be easily identified. If markers are used in a plurality of combinations, the identification numbers “1” to “8” will be repeatedly used, so that the number of bits used can be suppressed. Further, both the marker, to which the last identification number has been assigned, and EOI are contained in the rearmost packet signal. Thus, not only the last one of divided image files can be notified, but also the last value of the identification numbers can be notified. Also, the number of packet signals can be set arbitrary.

The present invention has been described based upon illustrative embodiments. These exemplary embodiments are intended to be illustrative only and it will be obvious to those skilled in the art that various modifications to constituting elements and processes could be developed and that such modifications are also within the scope of the present invention.

In the exemplary embodiment described above, JPEG is used to compress the original frames. However, this should not be considered as limiting and, for example, the transmitting apparatus 10 and the receiving apparatus 50 may use other compression techniques than JPEG. Not only still images but also moving images may be compressed. MPEG (Moving Picture Experts Group) is used to compress the moving images. According to this modifications, the exemplary embodiment and its modifications of the present invention are applicable to various types of compression techniques.

While the exemplary embodiments of the present invention and their modifications have been described using specific terms, such description is for illustrative purposes only, and it is to be understood that changes and variations may still be further made without departing from the spirit or scope of the appended claims.

What is claimed is:

1. A data processing apparatus, comprising:
an input unit which inputs an image frame;
an insertion unit which inserts a plurality of markers into the image frame inputted by said input unit wherein each marker is defined as a pattern that is not scheduled to appear in data of the image frame; and
an output unit which outputs the image frame into which the plurality of markers are inserted by said insertion unit,
wherein said insertion unit divides the image frame into a plurality of parts based on a data size storable in a radio packet, and inserts the markers between the divided parts of the image frame.

2. A data processing apparatus according to claim 1, wherein said insertion unit defines a predetermined number of markers as one combination of markers, and inserts the markers in units of an integral multiple of the number of markers contained in one combination.

3. A data processing apparatus according to claim 2, wherein said insertion unit assigns mutually different identification numbers to markers in one combination, and repeatedly use the identification numbers used for one combination, for each marker in different combinations.

4. A data processing apparatus according to claim 1, wherein said insertion unit inserts markers into a leading image frame and an ending image frame, and
wherein said output unit outputs the image frame which is so divided into the plurality of parts as to contain the markers therein.

5. A data processing apparatus according claim 1, wherein said insertion unit assigns an identification number to each of the markers and appends a marker indicating the end of the image frame, and
wherein said output unit outputs the image frame which has been so divided into the plurality of parts as to contain the markers, and a marker to which an identification number is assigned and a marker indicating the end of the image frame are contained in the rearmost image frame.

6. A data processing apparatus, comprising:
an input unit which inputs a plurality of divided parts of an image frame, respectively; and
a processing unit which processes the image frame, inputted by said input unit, which has been divided into the plurality of parts,
wherein the image frame inputted by said input unit is such that an original image frame is divided into a plurality of parts based on a data size storable in a radio packet, and a marker defined as a pattern that is not scheduled to appear in data of the original frame is appended to each image frame, and
wherein said processing unit recognizes an acquisition status of the each image frame based on the marker.

7. A data processing apparatus according claim 6, wherein when an unacquired image frame is detected, said processing unit requests the retransmission of said image frame.

8. A transmitting method, comprising:
inputting an image frame;
inserting a plurality of markers into the image frame inputted by said inputting wherein the marker is defined as a pattern that is not scheduled to appear in data of the image frame; and
outputting the image frame into which the plurality of markers have been inserted,
wherein said inserting divides the image frame into a plurality of parts based on a data size storable in a radio packet and inserts the markers among the divided parts of the image frame.

9. A receiving method, comprising:
inputting a plurality of divided parts of an image frame, respectively; and
processing the image frame, inputted by said inputting, which has been divided into the plurality of parts,
wherein the image frame inputted by said inputting is such that an original image frame is divided into a plurality of parts based on a data size storable in a radio packet, and a marker defined as a pattern that is not scheduled to appear in data of the original frame is appended to each image frame, and
wherein said processing recognizes an acquisition status of the each image frame based on the marker.
